(19) United States
(12) Patent Application Publication
(10) Pub. No.: US 2026/0280921 A1
(43) Pub. Date: Sep. 17, 2026

(54) STORAGE MEDIUM STORING CONFERENCE SUPPORT PROGRAM, CONFERENCE SUPPORT METHOD, AND CONFERENCE SUPPORT SYSTEM

(71) Applicant: CANON KABUSHIKI KAISHA, Tokyo (JP)

(72) Inventors: JUN TANAKA, Ibaraki (JP); RYUTA UEDA, Tokyo (JP)

(21) Appl. No.: 19/553,740

(22) Filed: Mar. 2, 2026

(30) Foreign Application Priority Data
Mar. 17, 2025 (JP) 2025-042540

(51) Int. Cl. H04L 12/18; G06V 10/25; G06V 10/74; G06V 20/40; H04L 65/1089; H04L 65/403

(52) U.S. Cl. CPC H04L 12/1831; G06V 10/25; G06V 10/761; G06V 20/41; H04L 65/1089; H04L 65/403

(57) ABSTRACT

A medium storing a conference support program capable of allowing a user to easily understand a content of a conference. The program causes a computer to execute a step of obtaining a video image and a speech of a conference as conference information, a step of extracting a topic of the conference from the conference information, a step of identifying image regions included in the video image as attention regions based on the extracted topic, a step of extracting related items related to the attention regions from the speech within a playback time range of the attention regions and contents in the image regions, a step of generating correspondence entities by associating the attention regions and the related items, and a step of generating a group by collecting the correspondence entities including the attention regions having a predetermined similarity or more based on contents included in the extracted related items.

This application claims the benefit of Japanese Patent Application No. 2025-042540, filed March 17, 2025 which is hereby incorporated by reference herein in its entirety.

### BACKGROUND

### Field of the Technology

The aspect of the embodiments relates to a storage medium storing a conference support program, a conference support method, and a conference support system.

### Description of the Related Art

In recent years, a Web conference is known in which a plurality of participants can participate via an Internet line. Each participant can participate in the Web conference via an information processing terminal. The participant can speak using a microphone connected to the information processing terminal. The participant can show their appearance to other participants using a camera connected to the information processing terminal. Further, in the Web conference, one participant can share the same screen with other participants by sharing a screen displayed with the other participants.

Such a Web conference can be recorded by an arbitrary terminal. By playing back the recorded conference data, it is possible to look back on the conference.

Japanese Patent Laid-Open Publication No. 2023-113052 discloses a technology that calculates an attention level of a participant toward a topic or speech based on facial expressions, motions, and speech contents of the participant in the recording data in which the Web conference is recorded, and identifies other Recording data having a similar attention level.

By the way, in looking back on a conference, it is inefficient to understand the contents by viewing the entire recording data. It is desirable if a user can easily understand the contents of the conference.

### SUMMARY

The present disclosure provides a mechanism capable of allowing a user to easily understand a content of a conference.

Accordingly, an aspect of the embodiments provides a non-transitory computer-readable storage medium storing a conference support program for causing a computer to execute a conference obtainment step of obtaining a video image of a conference and a speech of a participate of the conference as conference information, a topic extraction step of extracting a topic of the conference information from the obtained conference information, a region identification step of identifying a plurality of image regions included in the video image as attention regions based on the extracted topic, a relation extraction step of extracting related items related to the attention regions from the speech within a playback time range of the attention regions and contents in the image regions, a correspondence generation step of generating correspondence entities by associating the attention regions and the related items, and a group generation step of generating a group by collecting the correspondence entities including the attention regions having a predetermined similarity or more based on contents included in the extracted related items.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing a hardware configuration of a conference support system according to a first embodiment.

FIG. 2 is a block diagram showing a software configuration of the conference support system.

FIG. 3 is a screen view showing an example of a video image included in conference information.

FIG. 4 is a flowchart showing a process of the conference information in the first embodiment.

FIG. 5 is an explanatory diagram showing a display example of grouped correspondence entities.

FIG. 6 is a flowchart showing a process of extracting an attention region from the conference information in the first embodiment.

FIGS. 7A to 7D are explanatory diagrams showing examples of images cut out from a frame image constituting the video image by the process in FIG. 6.

FIG. 8 is a flowchart showing a process of extracting a similarity of the correspondence entity in the first embodiment.

FIG. 9 is a flowchart showing a grouping process of the correspondence entities in the first embodiment.

FIGS. 10A to 10D are diagrams for explaining correspondence tables of the correspondence entities in the first embodiment.

FIG. 11 is a flowchart showing a process of extracting the attention region from the conference information in a second embodiment.

FIG. 12 is a flowchart showing a process of extracting the correspondence entity from the conference information in a third embodiment.

FIG. 13 is a block diagram showing a software configuration of a conference support system in a fourth embodiment.

FIG. 14 is a flowchart showing a process of the conference information in the fourth embodiment.

FIG. 15 is a block diagram showing a software configuration of a conference support system in a fifth embodiment.

FIG. 16 is a flowchart showing a process of the conference information in the fifth embodiment.

### DESCRIPTION OF THE EMBODIMENTS

Hereinafter, embodiments of the present disclosure will be described in detail with reference to the attached drawings. However, the configurations described in the following embodiments are merely examples, and the scope of the present disclosure is not limited by the configurations described in the embodiments. For example, each of the units constituting the present disclosure can be replaced with any unit that can exhibit the same function. In addition, an arbitrary constituent may be added. Any two or more configurations (features) of the embodiments can be combined.

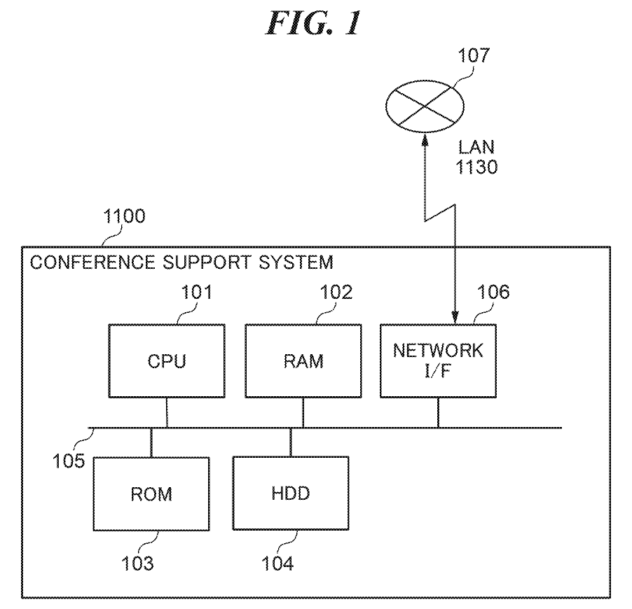

Hereinafter, the first embodiment will be described with reference to FIGS. 1 to 10D.

FIG. 1 is a block diagram showing a hardware configuration of a conference support system according to the first embodiment. As shown in FIG. 1, the conference support system 1100 as an information processing apparatus is connected to the Internet 107 via a network such as a LAN 1130. The conference support system 1100 has a CPU 101, a RAM 102, a ROM 103, an HDD (a hard disk drive as an example of an external storage device) 104, and a network interface 106. Note that as the conference support system 1100, for example, a desktop personal computer can be used, but the disclosure is not limited thereto, and for example, a notebook personal computer, a tablet terminal, a smartphone, or the like can also be used.

The CPU 101 is a computer that executes programs and the like stored in the ROM 103 or the HDD 104. Thereby, the CPU 101 can execute each process (control method) described later. For example, the ROM 103 stores a program for operating the computer as the conference support system 1100. Further, the CPU 101 reads a control program stored in the HDD 104. The CPU 101 executes the control program read by using the RAM 102 as a work area.

The HDD 104 stores an application program group, an operating system (OS), a plurality of types of learning models used as modules of the conference support system, and the like. Further, the HDD 104 stores recording data (hereinafter also referred to as conference information) of a conference obtained by the network interface 106 via the Internet 107. Furthermore, the HDD 104 stores data related to a summary of the conference information processed by the CPU 101.

The network interface 106 is connected to the Internet 107 via the LAN 1130. The network interface 106 controls input and output of information via the LAN 1130.

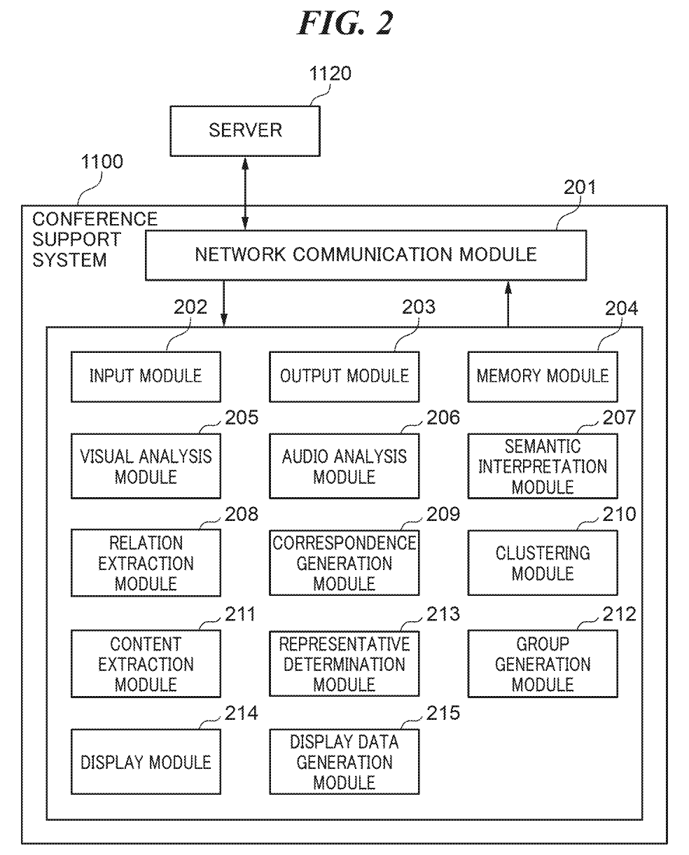

FIG. 2 is a block diagram showing a software configuration of the conference support system. FIG. 2 mainly shows a functional configuration in the conference support system 1100 as the information processing apparatus. A program for achieving the functions included in the conference support system 1100 is stored in any of the RAM 102, the ROM 103, and the HDD 104. The CPU 101 achieves various functions of the conference support system 1100 by reading and executing the program. Further, in the conference support system 1100, software for achieving various functions using a network or memory storage operates. The conference support system 1100 has functions of a network communication module 201, an input module 202, an output module 203, a memory module 204, a visual analysis module 205, an audio analysis module 206, and a semantic interpretation module 207. Further, the conference support system 1100 has functions of a relation extraction module 208, a correspondence generation module 209, a clustering module 210, a content extraction module 211, a group generation module 212, a representative determination module 213, a display data generation module 215, and a display module 214.

The network communication module 201 operates the network interface 106 to transmit and receive information via the LAN 1130. The network communication module 201 transmits and receives information to and from, for example, a server 1120 connected via the Internet 107.

The input module 202 (a conference obtainment step) receives input information input from a user who uses the conference support system 1100. Further, the input module 202 obtains the conference information from the server 1120 or the like in which web conference information is stored via the network communication module 201. The output module 203 receives a result processed according to the input information received by the input module 202. The output module 203 outputs the processed result to the server 1120 via the network communication module 201, for example. The memory module 204 manages non-volatile information in the conference support system 1100. The memory module 204 holds history information related to the conference information processed in the conference support system 1100 and various settings as the non-volatile information. Further, the memory module 204 holds the conference information obtained by the input module 202. The memory module 204 holds processed information processed by the visual analysis module 205, audio analysis module 206, and semantic interpretation module 207. The memory module 204 holds the non-volatile information in, for example, any of the HDD 104, the RAM 102, or the ROM 103.

The visual analysis module 205 analyzes the conference information stored in the memory module 204. The visual analysis module 205 extracts text included in the frame image of the video image of the conference information. The visual analysis module 205 detects an object included in the frame image of the video image of the conference information. The visual analysis module 205 detects, for example, a mouse pointer, a face image of a participant, a graph, a table, and the like as the objects to be detected.

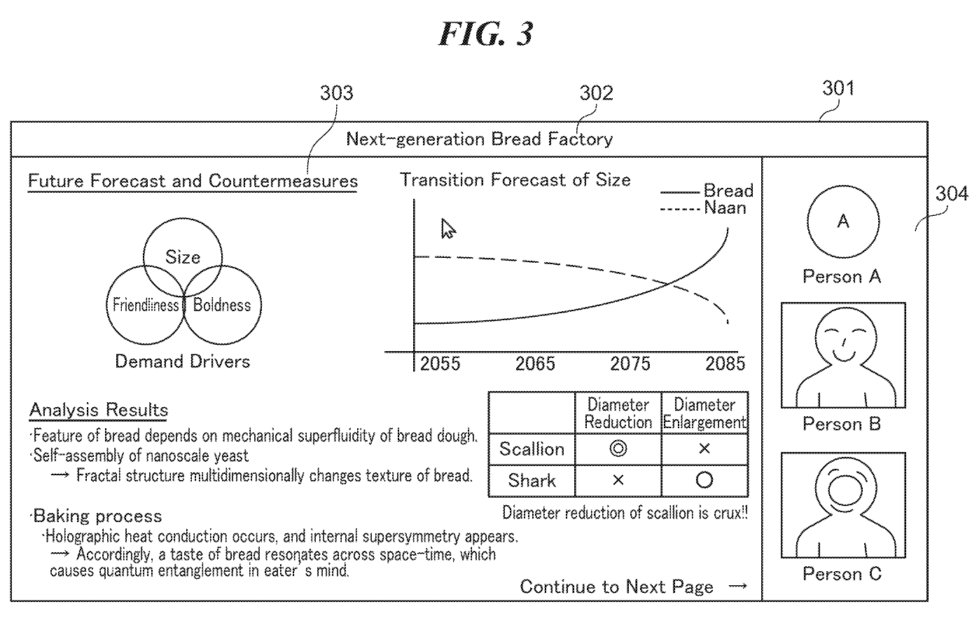

The audio analysis module 206 analyzes the conference information stored in the memory module 204. The audio analysis module 206 analyzes a speech included in the conference information and converts the speech into text. The semantic interpretation module 207 interprets meanings of the text and objects detected by the visual analysis module 205. Further, the semantic interpretation module 207 interprets a meaning included in the data converted into the text by the audio analysis module 206. Here, the "interpretation of meaning" refers to, for example, obtaining a content describing the text and the object as objective variables by inputting the detected text and object as explanatory variables into a predetermined language learning model. Further, the semantic interpretation module 207 extracts a topic (a topic extraction step) included in the data converted into the text. The semantic interpretation module 207 calculates, for example, a similarity for the text interpreted by the interpretation of meaning. Regarding the text having a predetermined similarity or more, the semantic interpretation module 207 extracts the text having an occurrence frequency of a predetermined number of times or more within a predetermined time period as a "topic" within the predetermined time period. Further, the visual analysis module 205 may detect an object and text included in a video image 301 shown in FIG. 3 described later by object detection and character detection. The semantic interpretation module 207 may interpret meanings included in the detected object and text. The visual analysis module 205 may extract the interpreted meaning as a topic.

The visual analysis module 205 identifies each of a plurality of image regions included in the video image 301 as an attention region based on the extracted topic (an example of a region identification step). The visual analysis module 205 detects, for example, an object and text of each region included in the video image 301 by object detection and character detection. The semantic interpretation module 207 obtains, for example, a content describing the text and the object as objective variables by inputting the detected text and object as explanatory variables into a predetermined language learning model. Regarding the object and text interpreted by the semantic interpretation module 207, the visual analysis module 205 identifies a region including an object and text having a meaning related to the extracted topic as the attention region. Further, the visual analysis module 205 may identify an image region, which is an object (including text) designated by a pointer, based on a movement of a mouse pointer or a pointer mark (pointer) of a presentation application included in the video image 301. The semantic interpretation module 207 may interpret the meaning of the object designated by the pointer and use the interpreted meaning as a topic. The designation of an object by the movement of the pointer may include, for example, an operation of surrounding an object included in the video image 301, an operation of moving along the text, an operation of repeatedly moving between two objects, and the like.

The relation extraction module 208 extracts a related item related to the attention region from speech in the playback time range of the attention region and contents in the image region (a relation extraction step). The relation extraction module 208 extracts text data obtained by summarizing the text data in which speech data included in the playback time range of the attention region is transcribed as the related item. The relation extraction module 208 may use information determined to have a high similarity by the semantic interpretation module 207 in the video image 301 other than the playback time range included in the conference information as the related item. Further, the relation extraction module 208 may add information determined to have a high similarity in conference information different from the conference information included in the memory module 204 or other data obtained from the server 1120 via the network communication module 201 as the related item.

The correspondence generation module 209 generates a correspondence entity in which the attention region and the related item are associated with each other (correspondence generation process). The correspondence generation module 209 generates, for example, a correspondence entity in which the related item is associated with the attention region in a one-to-one correspondence. That is, the correspondence generation module 209 generates a correspondence entity in which a summary of the attention region is associated with the attention region. The relation extraction module 208 may extract a title of the generated correspondence entity based on terms included in the related item. The relation extraction module 208 may use a term with the highest frequency of occurrence among the terms included in the related item as the title of the correspondence entity. The correspondence generation module 209 may include the extracted title in the correspondence entity.

The clustering module 210 performs clustering of the correspondence entities according to a similarity between one correspondence entity and another correspondence entity. The clustering module 210 includes, for example, two correspondence entities having a high similarity in one cluster. The content extraction module 211 extracts a common content regarding the correspondence entities included in one cluster. The content extraction module 211 tags the common content for each correspondence entity. The group generation module 212 further subdivides the correspondence entities included in one group into a plurality of groups based on a tagged item added by the content extraction module 211. Note that when all the correspondence entities included in one cluster are tagged with the same item, the group generation module 212 may use the one cluster as one group as it is without subdividing it. The display data generation module 215 generates data for displaying the grouped correspondence entities. The display data generation module 215 generates data for displaying the correspondence entities for each group. The display module 214 performs control to display the data of the correspondence entities on, for example, a display not shown.

FIG. 3 is a screen view showing an example of the video image included in the conference information. The screen shown in FIG. 3 is, for example, one frame image of the video image included in the conference information.

The video image (frame image) 301 is included in the recording data recorded as the conference information. In addition to the video image (frame image) 301, the conference information includes the text data transcribed from speech, participant information, associated attachment files, and the like. A title display section 302 is a conference title section displayed in the video image (frame image) 301. Text included in the title display section 302 is a conference name added by a user who holds a web conference to identify the conference. The conference name is included in the video image (frame image) 301 and may also be included in a file name of the conference information as text data. A conference screen 303 is an image section displayed in common to the participants of the conference in the video image (frame image) 301. On the conference screen 303, a screen projected to the conference participant user is displayed. The conference screen 303 also includes the pointer mark of the presentation application and the mouse pointer. In the present embodiment, a Venn diagram, a description of the Venn diagram, a graph, a table, and the mouse pointer are shown on the conference screen 303. A participant display section 304 is a section where information related to the conference participants is displayed in the video image (frame image) 301. In the participant display section 304, for example, an image of a participant captured by a camera is displayed. Further, in the participant display section 304, for example, an icon indicating a user is displayed.

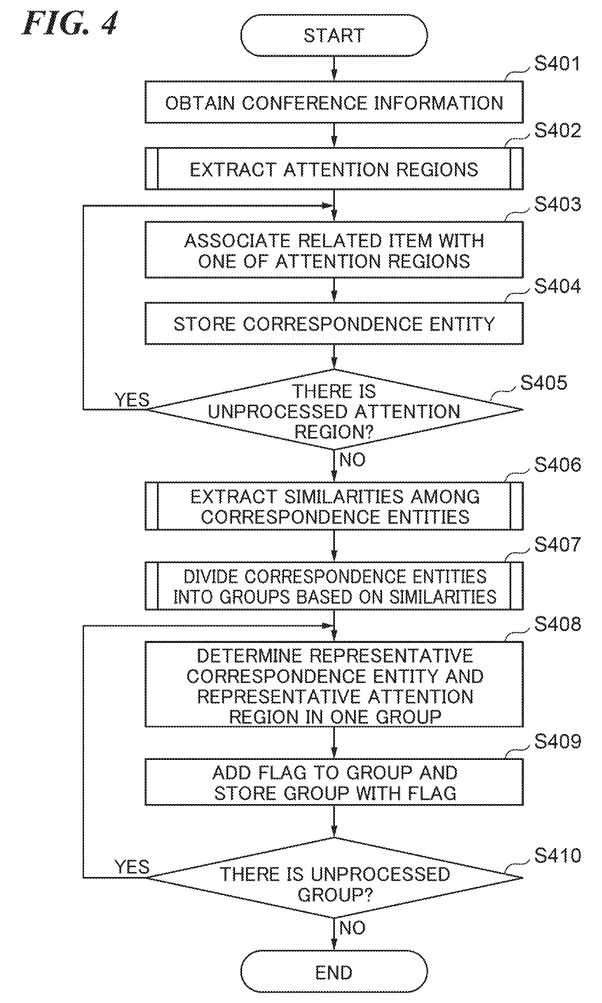

FIG. 4 is a flowchart showing a process of the conference information. This flowchart is started when the input module 202 receives a conference-information formatting request from a user. When the input module 202 receives the conference-information formatting request, the input module 202 instructs the visual analysis module 205 on a conference to be processed.

In a step S401, the visual analysis module 205 obtains the conference information from the memory module 204. The visual analysis module 205 obtains the conference information corresponding to the conference instructed by the input module 202.

In a step S402, the visual analysis module 205 obtains the attention regions from the conference information. Each of the attention regions is a part of the video image (conference video) 301 that attracted attention of persons who participated during the conference, and is extracted from the video image (conference video) 301 as data including an image and time information indicating start and end in the conference.

In a step S403, the relation extraction module 208 extracts the related item to be added to the attention region. Further, the correspondence generation module 209 associates the related item extracted with the attention region. The relation extraction module 208 includes the text data obtained by transcribing speech data included in a time corresponding to a time (time information) during which the attention region is displayed, or the text data obtained by summarizing the text data by the semantic interpretation module 207. Further, the related item includes information determined to have a high similarity in content by the semantic interpretation module 207 among information other than the video image (conference video) 301 included in the conference information. The related item may include another information included in the memory module 204 or information obtained via the network communication module 201. The correspondence generation module 209 associates the extracted related item with the corresponding attention region to generate a correspondence entity. The correspondence generation module 209 generates a correspondence entity by, for example, associating one related item with one attention region.

In a step S404, the correspondence generation module 209 stores the generated correspondence entity in the memory module 204.

In a step S405, the visual analysis module 205 determines whether there is an unprocessed attention region. When there is an unprocessed attention region, the process returns to the step S403. Here, when a plurality of attention regions exist in the frame image, the visual analysis module 205 determines that the unprocessed attention region exists and the process returns to the step S403. Further, when a plurality of related items exist for one attention region, the process returns to the step S403 to generate a correspondence entity for each related item.

By the processes up to this point, it is possible to extract information (correspondence entity) of the attention region from the conference information. Therefore, partial reference to the conference contents becomes easy by referring to the attention region extracted here. Further, it is also possible to end the flowchart here and only store the correspondence entities. Furthermore, subsequent processes may be performed by a separate apparatus or at a separate timing.

In a step S406, when it is determined that there is no unprocessed attention region, the clustering module 210 extracts the similarity among the correspondence entities. The clustering module 210 extracts the similarity of the correspondence entity according to the similarity between the correspondence entities. The clustering module 210 divides the correspondence entities into clusters according to the similarity of the correspondence entity (a clustering step).

In a step S407, the group generation module 212 groups the correspondence entities based on the extracted similarity (a group generation step). The group generation module 212, for example, collects the correspondence entities having a predetermined similarity or more as one group.

In a step S408, the representative determination module 213 determines a representative correspondence entity to be a representative of the group regarding one of the groups generated in the step S407 (a representative determination step). Among the correspondence entities included in the group, the representative determination module 213 determines a correspondence entity having the highest relevancy with other correspondence entities as the representative correspondence entity. Further, the representative determination module 213 determines the attention region included in the representative correspondence entity as a representative attention region. The representative determination module 213 may, for example, set a correspondence entity having the longest playback time range of the attention region as the representative correspondence entity and set the attention region included in the representative correspondence entity as the representative attention region. Further, the representative determination module 213 may calculate the similarity between the related items included in the correspondence entity and other correspondence entities. The representative determination module 213 may determine a correspondence entity having the highest similarity with other correspondence entities as the representative correspondence entity and determine the attention region included in the representative correspondence entity as the representative attention region. The representative determination module 213 may determine a correspondence entity having the earliest playback start time as the representative correspondence entity and determine the attention region included in the correspondence entity as the representative attention region. Further, the representative determination module 213 may determine a correspondence entity having the highest attention level of the attention region calculated by the semantic interpretation module 207 as the representative correspondence entity and determine the attention region included in the representative correspondence entity as the representative attention region. Here, when interpreting the meaning of text, the semantic interpretation module 207 may calculate an attention level of the attention region from occurrence frequency of a specific word or the like. The representative determination module 213 adds an identifier for identifying the determined representative correspondence entity from the other correspondence entities to the corresponding correspondence entity. The identifier is, for example, a flag indicating that it is the representative correspondence entity.

In a step S409, the representative determination module 213 adds the flag indicating the determined representative correspondence entity to the generated group. The representative determination module 213 stores the group to which the flag is added in the memory module 204.

In a step S410, the representative determination module 213 determines whether there is a group for which a representative attention region has not been determined. When there is a group for which the representative attention region has not been determined, the process returns to the step S408. On the other hand, when there is no group for which the representative attention region has not been determined, the process by this flowchart ends.

By these processes, the attention region can be extracted from the conference information and stored in association as the correspondence entity. This enables to easily refer to a part of the conference information and to easily access information related thereto. Further, by grouping the correspondence entities by the processes from the step S406, it is possible to easily understand only a portion related to one of the attention regions having similar contents. Since the attention regions having similar contents form a group as one topic, it is possible to understand the connection between the topics. For example, the attention regions having similar contents become a group of a plurality of correspondence entities related to the Venn diagram. By viewing the grouped correspondence entities, it becomes possible to easily understand the contents related to the topic in a short time. The attention region processed from the step S406 may be prepared by another apparatus or another method.

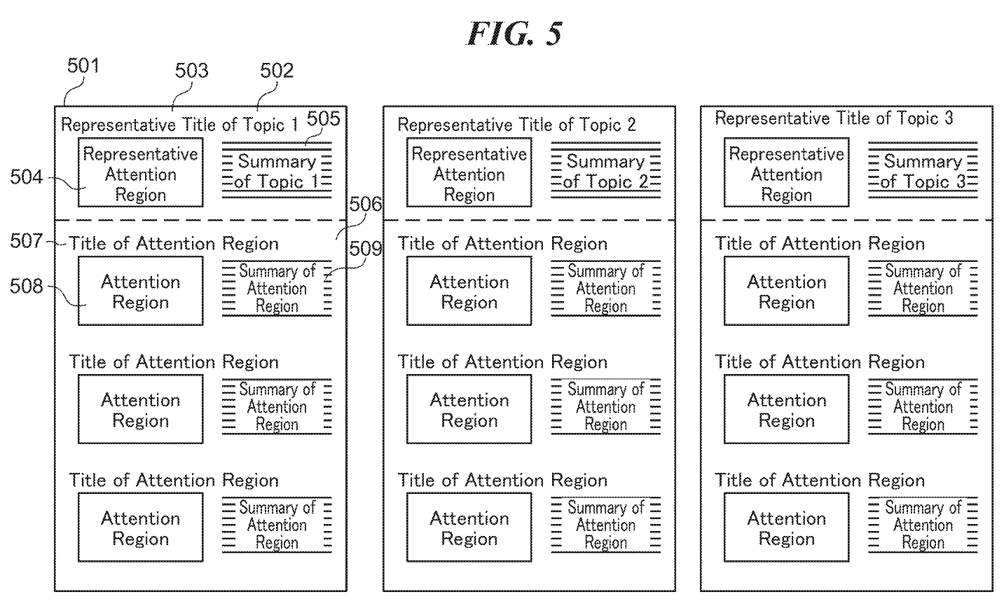

FIG. 5 is a display example of the grouped correspondence entities. The input module 202 receives, for example, a request for transmitting display data of the grouped correspondence entities from a user. The output module 203 displays, for example, a screen as shown in FIG. 5 on a display not shown in response to the request for transmitting display data.

A group display section 501 is used for displaying information related to one of the groups generated in the step S407. In the example in FIG. 5, three group display sections 501 are arranged because three groups exist. The group display section 501 includes a representative-attention-region display section 502 and an attention region display section 506. In the representative-attention-region display section 502, one representative attention region of the group is arranged. The representative-attention-region display section 502 is located, for example, at the top of the display. The attention region display section 506 is located below the representative-attention-region display section 502. In the attention region display section 506, a plurality of correspondence entities are displayed. The plurality of correspondence entities included in the attention region display section 506 are arranged from top to bottom, for example, in the order of earlier playback start time. In the attention region display section 506, all the correspondence entities included in the group are arranged. As an example, the representative correspondence entity of the group is arranged at the top on the display. A plurality of other correspondence entities in the group are arranged downwardly below the arrangement position of the representative correspondence entity. The other correspondence entities in the group are listed, for example, in the order of earlier playback start time.

The representative-attention-region display section 502 is used for displaying the representative correspondence entity of the group. In the representative-attention-region display section 502, the image of the attention region and the related item associated in the step S403 are displayed. In a representative-attention-region title section 503, character information corresponding to the title of the attention region among the summary text data associated in the step S403 is displayed. In a representative-attention-region image display section 504, the representative attention region included in the representative correspondence entity is displayed.

In a representative-attention-region summary display section 505, the summary text data associated in the step S403 is displayed. In the example of FIG. 5, all the text data are displayed in the representative-attention-region summary display section 505, but a part of the text data may be displayed. All the text data may be generated by another ways (for example, mouse rollover, pop-up of another window by clicking, etc.). Further, in the representative-attention-region summary display section 505, the related item extracted by the relation extraction module 208 may be displayed in addition to the text data.

The attention region display section 506 is used for displaying information related to the correspondence entity. Similar to the representative-attention-region display section 502, an attention region title display section 507, an attention region image display section 508, and an attention region summary display section 509 related to the correspondence entity are arranged in the attention region display section 506. The attention region title display section 507, the attention region image display section 508, and the attention region summary display section 509 are arranged for each correspondence entity. In the present embodiment, the attention region image display section 508 is arranged on the left side in the attention region display section 506. The attention region summary display section 509 is arranged on the right side of the attention region image display section 508 of the corresponding correspondence entity. The attention region title display section 507 is displayed above the attention region image display section 508. The attention region title display section 507 is arranged, for example, between the attention region image display section 508 of another correspondence entity located above and the attention region image display section 508 of its own correspondence entity.

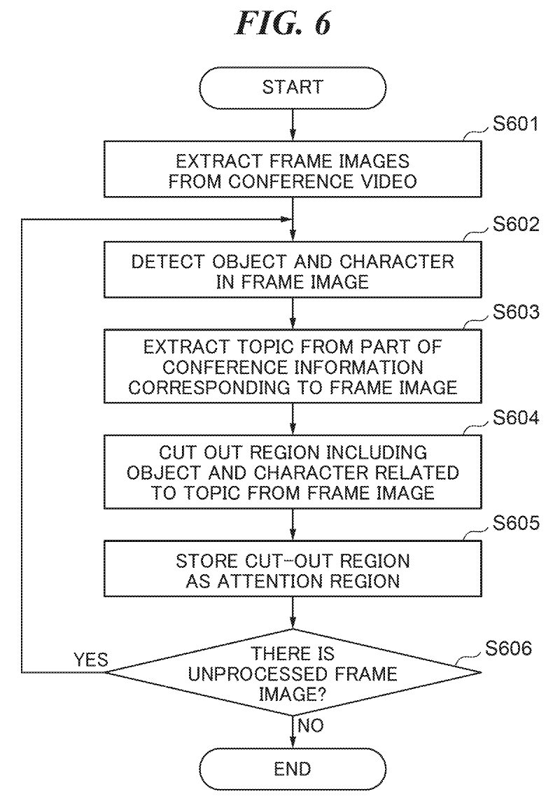

FIG. 6 is a flowchart showing a process of extracting the attention region from the conference information in the step S402 in FIG. 4.

In a step S601, first, the visual analysis module 205 obtains images from the conference information. Specifically, the visual analysis module 205 obtains each frame image from the video image (conference video) 301. When there is almost no change between the preceding and succeeding images, the visual analysis module 205 assumes that the same image is included in a plurality of frame images. The visual analysis module 205 uses a preset value for a threshold of presence/absence of change. In addition, the visual analysis module 205 may determine presence/absence of change using a difference in object detection results in an image. The visual analysis module 205 extracts images included in each region of the frame image.

In a step S602, the visual analysis module 205 performs object detection and character detection on one image extracted. The visual analysis module 205 detects what kind of object the image is by, for example, the object detection. Further, the visual analysis module 205 detects text by the character detection.

In a step S603, the semantic interpretation module 207 extracts a topic in a playback time range in which the image is extracted. The audio analysis module 206 converts speech data included in the conference information into text data. The semantic interpretation module 207 identifies information on what is being talked about based on the converted text data. Further, the visual analysis module 205 may function as a topic extraction module. Separately from the extracted image, the visual analysis module 205 obtains the movement of the mouse pointer and the pointer of the application in the video image 301. The visual analysis module 205 extracts information about a part pointed to by the pointer as a topic (a topic extraction step). The visual analysis module 205 detects, for example, the movement of the mouse pointer along a text image included in the video image 301. The visual analysis module 205 may identify content included in the text image as a topic based on the detected movement of the mouse pointer.

In a step S604, the visual analysis module 205 cuts out a region including information corresponding to the topic extracted in the step S603 from the image extracted in the step S601 based on the content detected in the step S602. That is, the visual analysis module 205 cuts out the region concerned as the attention region.

In a step S605, the visual analysis module 205 adds a display time (display start time and display end time) of the image in the video image 301 as the time information to the cut-out image, and stores it as the attention region.

In a step S606, the visual analysis module 205 determines whether there is an unprocessed frame image. When there is an unprocessed image, the process returns to the step S602. On the other hand, when there is no unprocessed image, the process by this flowchart ends.

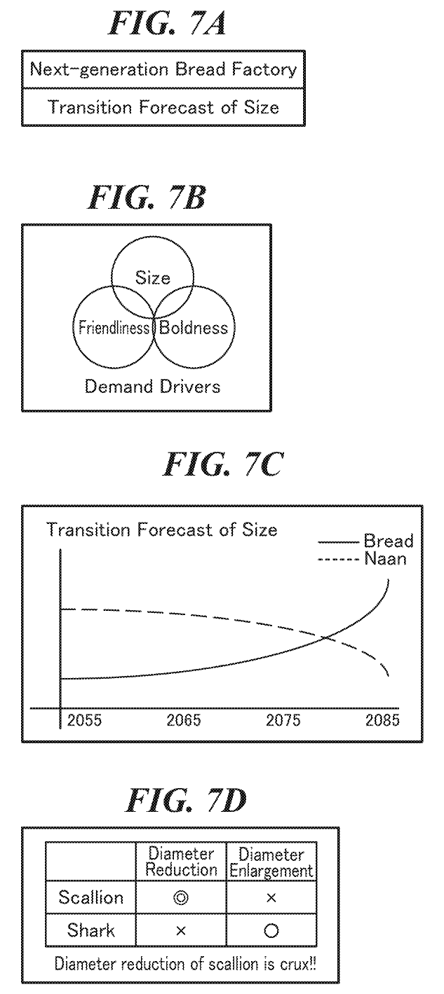

FIGS. 7A to 7D are explanatory diagrams showing examples of images cut out from the frame image constituting the video image by the process in FIG. 6. Here, the process for the video image 301 shown in FIG. 3 is described as an example.

In a case in FIG. 7A, the semantic interpretation module 207 determines that the topic relates to the title in the step S603. The visual analysis module 205 cuts out an image of a part indicating the title.

In a case in FIG. 7B, the semantic interpretation module 207 determines that the topic relates to the Venn diagram and its content in the step S603. The visual analysis module 205 cuts out an image of a part indicating the Venn diagram.

In a case in FIG. 7C, the visual analysis module 205 determines that the topic relates to a graph from the movement of the mouse pointer in the step S603. The visual analysis module 205 cuts out an image of a part indicating the graph.

In a case in FIG. 7D, the semantic interpretation module 207 determines that the topic relates to the word "green onion" in the step S603. The visual analysis module 205 cuts out an image of a corresponding part where "green onion" is detected as characters.

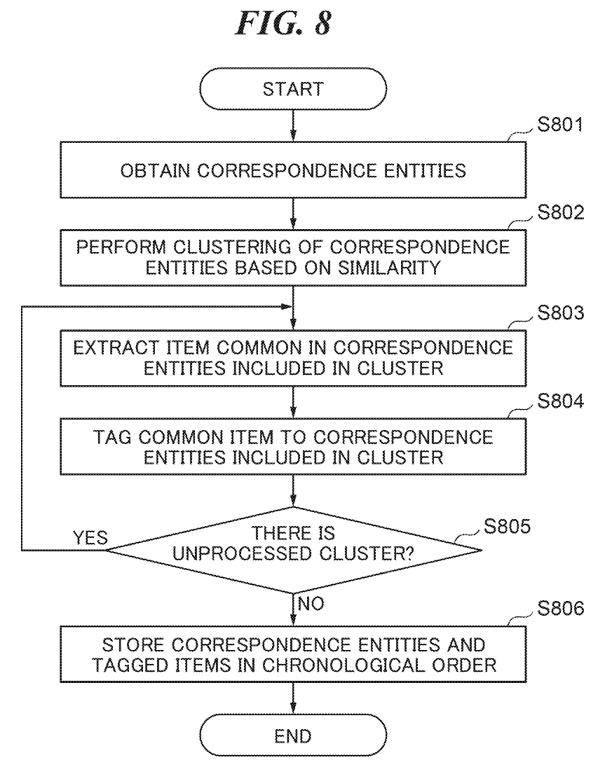

FIG. 8 is a flowchart showing a process of extracting the similarity of the attention region in the step S406.

In a step S801, the clustering module 210 obtains the correspondence entity stored in the step S404 from the memory module 204.

In a step S802, the clustering module 210 performs clustering on a plurality of correspondence entities obtained based on the similarity of contents (a clustering step). Regarding two correspondence entities, the clustering module 210 calculates the similarity so as to be higher as meanings become closer based on the contents processed by the semantic interpretation module 207. Regarding the correspondence entity having a predetermined similarity or more, the group generation module 212 performs clustering as one cluster.

In a step S803, the content extraction module 211 extracts contents common to the correspondence entities included in one cluster (a content extraction step). Among items common to the related items included in the correspondence entities, the content extraction module 211 extracts an item determined by the semantic interpretation module 207 to have the highest total similarity to all correspondence entities as a common item.

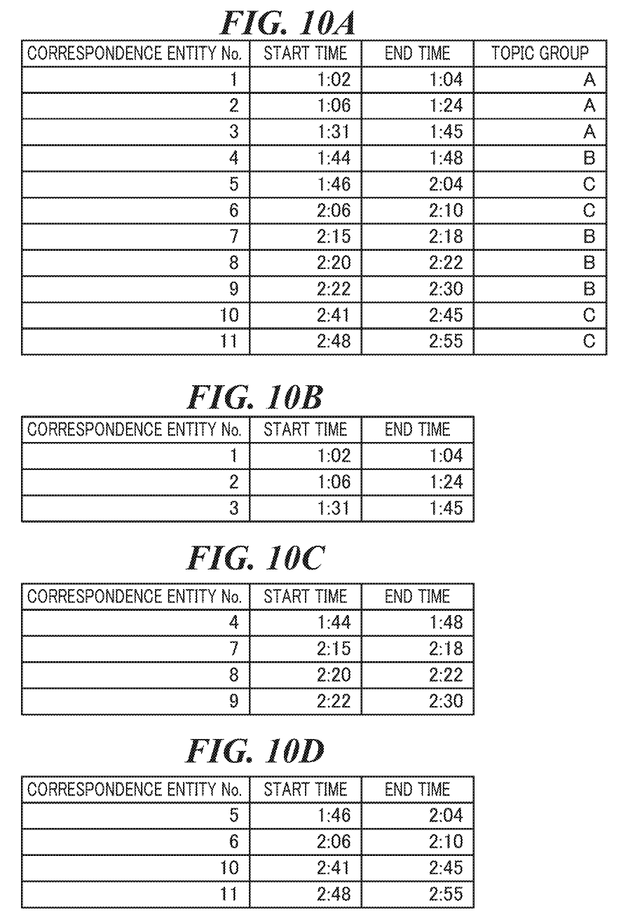

In a step S804, the content extraction module 211 tags the common item extracted in the step S803 to the correspondence entities included in one cluster. That is, the content extraction module 211 tags topic groups as A, B, and C to the correspondence entities as shown in FIG. 10A, for example.

In a step S805, the content extraction module 211 determines whether there is an unprocessed cluster. When there is an unprocessed cluster, the process returns to the step S803. On the other hand, when there is no unprocessed cluster, the process proceeds to a step S806.

In the step S806, the content extraction module 211 stores the correspondence entities and the tagged information in chronological order based on the time information included in the correspondence entities.

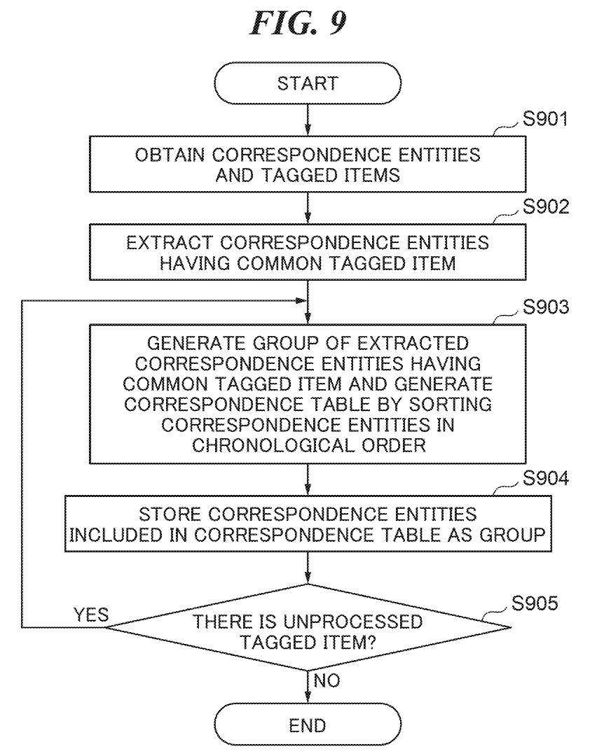

FIG. 9 is a flowchart showing a grouping process of the correspondence entities in the step S407.

In a step S901, first, the group generation module 212 obtains the similarities among the correspondence entities extracted in the step S406. The group generation module 212 obtains the correspondence entities themselves and the tagged items stored in the step S806.

In a step S902, the group generation module 212 extracts correspondence entities having the common tagged item from the correspondence entities obtained in the step S901.

In a step S903, the group generation module 212 generates a group including only the correspondence entities having the common tagged item extracted in the step S902. Regarding the correspondence entities included in the group, the group generation module 212 sorts them in the order of earlier playback start time to generate a correspondence table.

In a step S904, the group generation module 212 stores the correspondence entities included in the correspondence table generated in the step S903 as one group. The group generation module 212 stores the group in the memory module 204.

In a step S905, the group generation module 212 determines whether there is an unprocessed tagged item. When there is an unprocessed tagged item, the process returns to the step S903. On the other hand, when there is no unprocessed tagged item, the group generation module 212 ends the process by this flow.

FIGS. 10A to 10D are diagrams for describing the correspondence table of the correspondence entities generated in the steps S406 and S407. FIG. 10A is a table showing the relation of the correspondence entities generated by the process in the step S406. The relation of the correspondence entities is obtained by tagging information related to a topic to a correspondence entity no. (ID) uniquely indicating the correspondence entity, a start time, and an end time. The correspondence entities are stored in the order of start time (in chronological order) after being tagged in this manner. This allows transition of contents of a conference to be referred to in chronological order.

FIGS. 10B, 10C, and 10D, are tables showing groups generated by further dividing the cluster in FIG. 10A by the process in the step S407. The correspondence entities having the common tagged item are extracted from the table in FIG. 10A, and are stored as a group of correspondence entities. Thereby, as shown in FIG. 5, only the information related to the same topic in the conference can be collectively referred to.

Next, a process for displaying the generated group will be described. First, the input module 202 receives input of a display instruction to display a group (a reception step). Next, the display data generation module 215 generates the display data to be displayed on a display unit such as a display based on the display instruction input to the input module 202 (a display data generation step). As shown in FIG. 5, the display data generation module 215 arranges the correspondence entities in the order of earlier start time downward from the correspondence entity determined as the representative correspondence entity to form the display data. As shown in FIG. 5, the display data generation module 215 may generate the display data in which the correspondence entities related to a plurality of groups are arranged in a horizontal direction on the display unit. The display module 214 displays the generated display data on the display unit (a display step). This allows the user to view the grouped correspondence entities.

Further, the generated cluster may be displayed. The display of the cluster may be before or after grouping is executed. First, the input module 202 receives input of a display instruction to display the cluster (a reception step). Next, the display data generation module 215 generates the display data to be displayed on the display unit such as a display based on the display instruction input to the input module 202 (a display data generation process). As shown in FIG. 10A, the display data generation module 215 arranges a plurality of correspondence entities that are clustered into a topic group to form the display data. The display data generation module 215 arranges the correspondence entities from top to bottom in the order of earlier start time as the display data. In FIG. 10A, the correspondence entities are arranged in chronological order from correspondence entity No. 1 downward in the display data. The display module 214 displays the generated display data on the display unit (a display step). This allows the user to view the clustered correspondence entities.

Hereinafter, the second embodiment of the present disclosure will be described while mainly focusing on points different from the first embodiment. In the first embodiment, the visual analysis module 205 extracts the attention regions based on the object detection result in the image and the topic extracted from the conference information as in the process shown in FIG. 6. In the second embodiment, the attention regions are extracted by switching an image detection model based on a topic extracted from the conference information.

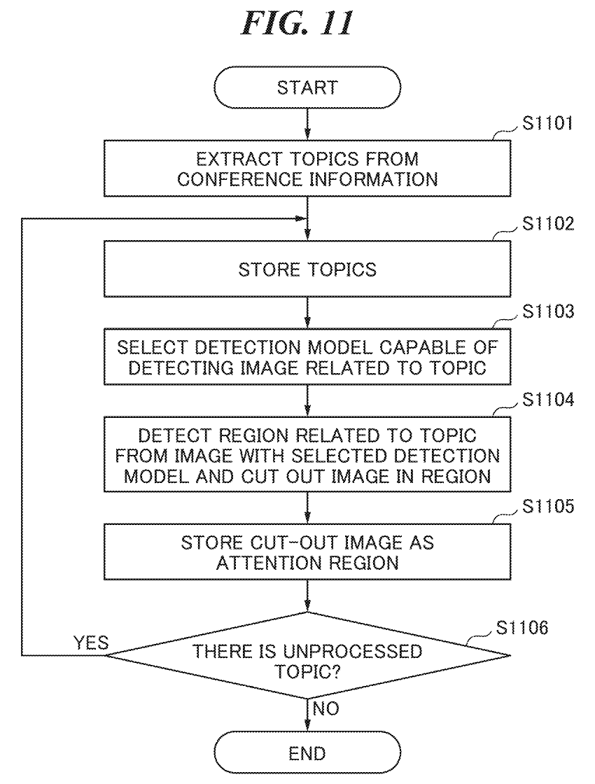

FIG. 11 is a detailed flowchart of the step S402 in the second embodiment.

In a step S1101, first, the semantic interpretation module 207 extracts topics from the conference information. Similar to the step S603, the topics are extracted based on contents of speech and text data interpreted by the semantic interpretation module 207. The visual analysis module 205 may extract a topic using a pointer in the video image (conference video) 301.

In a step S1102, the semantic interpretation module 207 or the visual analysis module 205 store the extracted topics in the memory module 204.

In a step S1103, the visual analysis module 205 selects a detection model capable of detecting an image related to a topic. In the example in FIG. 7B, the visual analysis module 205 identifies that the topic relates to the Venn diagram from the conference information, and selects a detection model capable of detecting the Venn diagram.

In a step S1104, the visual analysis module 205 detects a region related to the topic from the image included in the video image (conference video) 301 using the detection model selected in the step S1103, and cuts out an image in the region. In the example of FIG. 7B, the visual analysis module 205 detects the region as shown in FIG. 7B from the video image (conference video) 301 by the detection model capable of detecting the selected Venn diagram.

In a step S1105, the visual analysis module 205 stores the cut-out image as the attention region. The visual analysis module 205 stores a time during which the region was detected together with the attention region.

In a step S1106, the visual analysis module 205 determines whether there is an unprocessed topic. When there is an unprocessed topic, the process returns to the step S1102. On the other hand, when there is no unprocessed topic, the process by this flowchart ends.

Although the first embodiment is necessary to detect all objects and characters, the second embodiment detects by aiming at a part related to the topic, and therefore, the attention region more suitable for the topic can be extracted.

Hereinafter, the third embodiment of the present disclosure will be described while mainly focusing points different from the first and second embodiments. In the first embodiment, the attention regions are extracted based on the object detection result in the image and the topic extracted from the conference information as in the process shown in FIG. 6. In the second embodiment, the attention regions are extracted by switching the image detection model based on a topic extracted from the conference information. In the third embodiment, images that can be the attention region are detected first, and later whether they are appropriate as the attention regions is determined from the conference information.

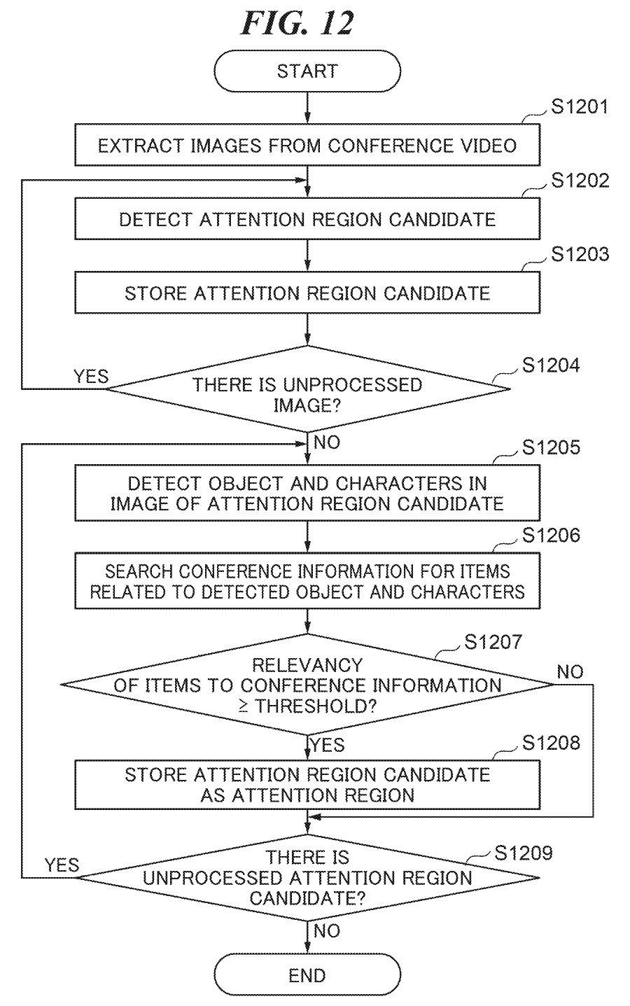

FIG. 12 is a detailed flowchart of the step S402 in FIG. 4 in the third embodiment.

In a step S1201, the visual analysis module 205 extracts images from the conference video. The visual analysis module 205 extracts images by obtaining images of frames from the video image (conference video) 301 similar to the step S601. When there is almost no change between the preceding and succeeding frame images, the visual analysis module 205 extracts them as the same image.

In a step S1202, the visual analysis module 205 detects an attention region candidate in the image. The visual analysis module 205 uses a detection model that has learned the attention region for detection of the attention region candidate. The detection model is generated by inputting the conference video and learning correct data in which a region that an operator feels attracted attention is labeled as an attention region. For example, this learning corresponds to the topic extraction step and the region identification step. That is, the topic extraction step and the region identification step use a detection model that has learned whether text and objects included in the video image 301 should be attention regions and inputs the video image 301 of the conference information as an explanatory variable and outputs a candidate for an attention region as an objective variable. The visual analysis module 205 thereby detects a region to be a candidate for the attention region only from the image.

In a step S1203, the visual analysis module 205 stores the attention region candidate in the memory module 204.

In a step S1204, the visual analysis module 205 determines whether there is an unprocessed image. When there is an unprocessed image, the process returns to the step S1202. On the other hand, when there is no unprocessed image, the process proceeds to a step S1205, and the visual analysis module 205 detects an object and characters from an image of in one attention region candidate.

In a step S1206, the visual analysis module 205 searches the conference information for related items related to the contents of the object and characters detected in the step S1205.

In a step S1207, the visual analysis module 205 calculates relevancy of the related items to the conference information from the contents searched in the step S1206, and determines whether the degree of relevancy is equal to or more than a preset threshold. When the degree of relevancy is less than the threshold, the process proceeds to a step S1209. On the other hand, when the degree of relevancy is equal to or more than the threshold, the process proceeds to a step S1208 and the visual analysis module 205 stores the attention region candidate as the attention region. The visual analysis module 205 determines the time information to be stored as the attention region from a time during which the attention region candidate was detected in the video image (conference video) 301 and the contents obtained by the search in the step S1206.

In the step S1209, the visual analysis module 205 determines whether there is an unprocessed attention region candidate. When there is an unprocessed attention region candidate, the process returns to the step S1205. On the other hand, when there is no unprocessed attention region candidate, the process by this flowchart ends.

In the third embodiment, the detection is performed using the model that detects an image to be a candidate for the attention region, and whether to store it as an attention region is determined according to the degree of relevancy to the conference. Therefore, it is possible to adjust the amount of stored attention regions by setting the threshold. Thereby, regarding a conference that a user feels important, many attention regions are stored, and otherwise, the amount of stored attention regions is reduced, so that necessary capacity can be saved.

Hereinafter, the fourth embodiment of the present disclosure will be described while mainly focusing points different from the first to third embodiments. In the fourth embodiment, LLMs (large language models) are used to extract an attention region and to obtain relation between attention regions.

An LLM is a natural language processing model trained using a large amount of text data, images, and video data, and takes a sentence as an input and outputs a sentence. Further, there are large language models capable of inputting image data and video data. In the LLM, an input sentence is called a "prompt".

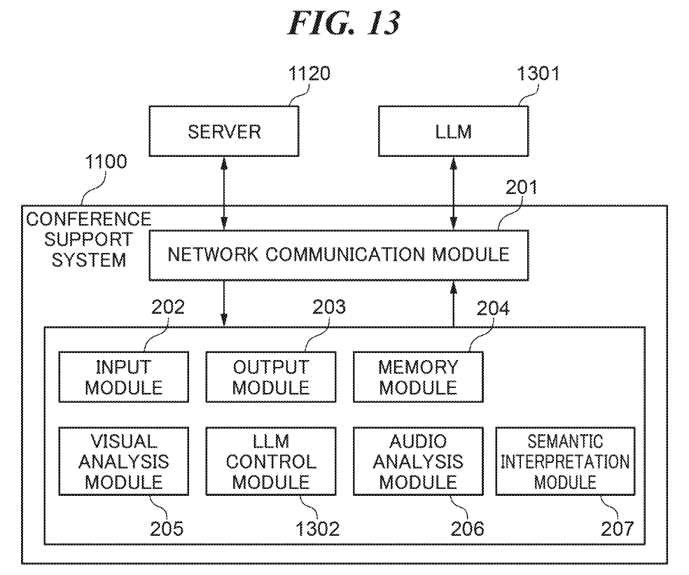

FIG. 13 is a software configuration diagram of the entire system in the fourth embodiment.

The conference support system 1100 is connected to an LLM 1301 via a network such as the LAN 1130. An LLM control module 1302, which is included in the conference support system 1100, inputs data to the LLM 1301 by transmitting prompts, image data, and video data to the LLM 1301. Processes by the LLM control module 1302 correspond to the topic extraction step, the region identification step, the relation extraction step, the correspondence generation step, and the group generation step.

The LLM control module 1302 generates data including a prompt to be input to the LLM 1301 and performs an input/output process for the LLM 1301 via the network communication module 201.

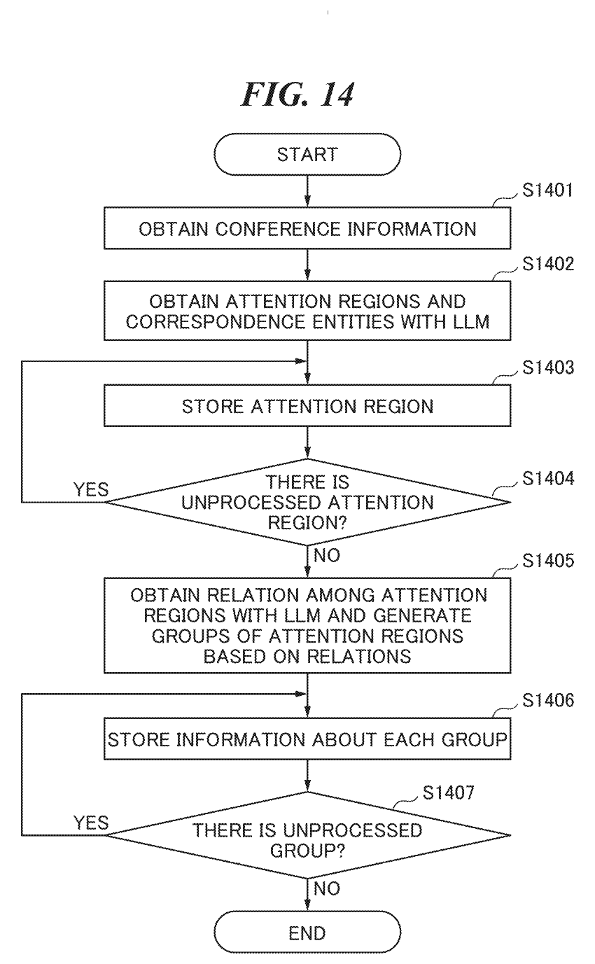

FIG. 14 is a flowchart showing a process of the visual analysis module 205 when a conference-information formatting request is received from the input module 202. When the input module 202 receives the conference-information formatting request, the input module 202 instructs the visual analysis module 205 on a conference to be processed. The visual analysis module 205 and the LLM control module 1302 perform the following processes based on the instruction.

In a step S1401, the visual analysis module 205 obtains the conference information from the memory module 204.

In a step S1402, the LLM control module 1302 obtains the attention region and the correspondence entity from the conference information. When the visual analysis module 205 inputs the conference information and the prompt to the LLM 1301, the LLM control module 1302 obtains the attention region based on the information output from the LLM 1301. The prompt is input by a user from the input module 202, for example. When the LLM control module 1302 receives the conference information from the visual analysis module 205, the LLM control module 1302 generates a prompt instructing to extract the attention region from the video image (conference video) 301 included in the conference information, and inputs the prompt to the LLM 1301 together with other conference information (the topic extraction step and the region identification step).

In a step S1403, the LLM control module 1302 stores one of the attention regions in the memory module 204.

In a step S1404, the LLM control module 1302 determines whether there is an unprocessed attention region. When there is an unprocessed attention region, the process returns to the step S1403. On the other hand, when there is no unprocessed attention region, the process proceeds to a step S1405, and the LLM control module 1302 obtains relation between the attention regions and generates a group of the attention regions based on the relation (the relation extraction step, the correspondence generation process, and the group generation step). The visual analysis module 205 obtains the relation by inputting all the attention regions extracted in the step S1402 to the LLM 1301, and generates a group. When the LLM control module 1302 receives an instruction for obtaining relation from the visual analysis module 205, the LLM control module 1302 generates a prompt for obtaining relation between the attention regions. The LLM control module 1302 obtains the relation between the attention regions by inputting, for example, the attention regions stored in the memory module 204 and the prompt to the LLM 1301. At this time, an instruction for determining the representative correspondence entity corresponding to the representative attention region is also included in the prompt. The LLM control module 1302 determines the representative correspondence entity according to the prompt.

In a step S1406, the LLM control module 1302 stores the information about the group in the memory module 204.

In a step S1407, the LLM control module 1302 determines whether there is an unprocessed group. When there is an unprocessed group, the process returns to the step S1406. On the other hand, when there is no unprocessed group, the process by this flowchart ends.

This makes it possible to extract the attention region and obtain the relation between the attention regions without individually using a detection model or calculating a degree of relevancy.

In the fourth embodiment, the LLM is used to extract the attention regions in the step S1402 and obtains the relation between the attention regions in the step S1405. However, the process of the step S1402 can also be achieved as the process in the S402 in the first to the third embodiments. Further, the process in the step S1402 can be achieved as it is, and the process in the step S1405 can be achieved as the processes in the steps S406 and S407 in the first embodiment.

Hereinafter, the fifth embodiment of the present disclosure will be described while mainly focusing on points different from the first to fourth embodiments. In the fourth embodiment, the LLM is used to extract the attention regions and obtains the relation between the attention regions, but in the fifth embodiment, both are performed at once by the LLM.

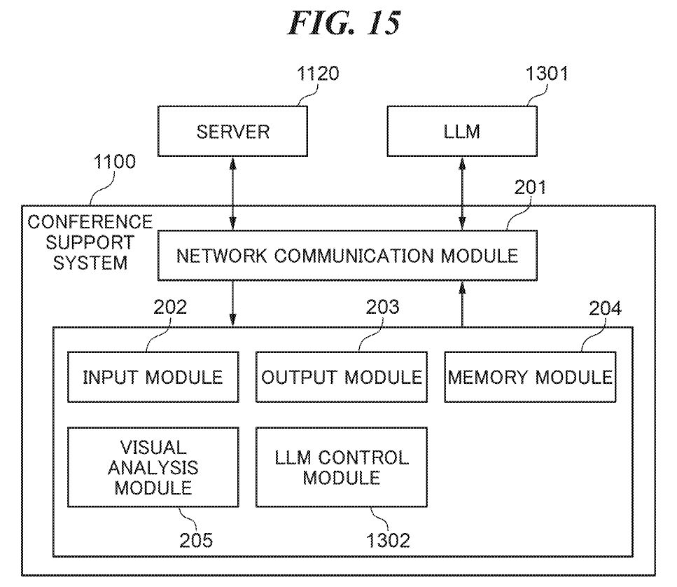

FIG. 15 is a software configuration diagram of the conference support system in the fifth embodiment. Similar to the fourth embodiment, the conference support system 1100 is connected to the LLM 1301 and includes the LLM control module 1302. Since extraction of the attention regions and obtainment of the relation are all performed by the LLM 1301, the audio analysis module 206 and the semantic interpretation module 207 are not included.

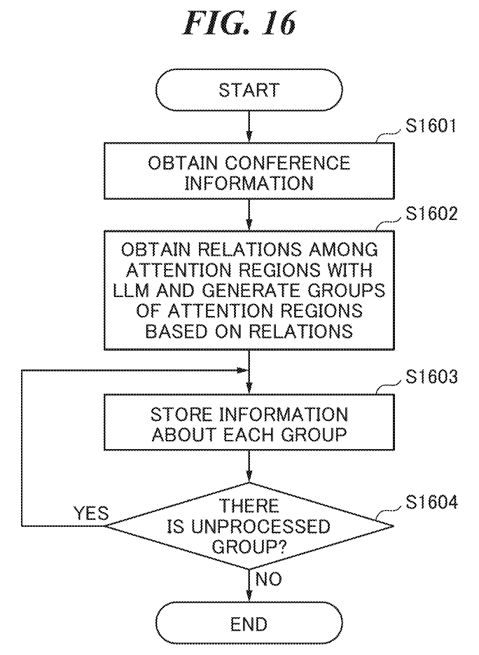

FIG. 16 is a flowchart showing a process of the visual analysis module 205 when a conference-information formatting request is received from the input module 202. When the input module 202 receives the conference-information formatting request, the input module 202 instructs the visual analysis module 205 on a conference to be processed. The visual analysis module 205 performs the following processes in response to the instruction.

In a step S1601, the visual analysis module 205 obtains the conference information from the memory module 204.

In a step S1602, the visual analysis module 205 extracts the attention regions and obtains the relations via the LLM control module 1302. When the LLM control module 1302 is instructed by the visual analysis module 205 to extract the attention region and obtain the relations, the LLM control module 1302 generates a prompt. In order to instruct the LLM to extract the attention regions and obtain the relations, a content for instructing generation of the correspondence tables as shown in FIGS. 10B to 10D is generated in the prompt. By inputting the conference information and the prompt to the LLM by the LLM control module 1302, the relation of the attention regions in FIGS. 10B to 10D are output from the LLM.

In a step S1603, the visual analysis module 205 stores information about the group in the memory module 204.

In a step S1604, the visual analysis module 205 determines whether there is an unprocessed group. When there is an unprocessed group, the process returns to the step S1603. On the other hand, when there is no unprocessed attention region, the process by this flowchart ends. This makes it possible to extract the attention regions and obtain the relation between the attention regions with a simpler configuration than the fourth embodiment.

According to the present disclosure, it is possible to provide a mechanism that allows a user to easily understand contents of a conference.

### Other embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or blu-ray disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. A non-transitory computer-readable storage medium storing a conference support program for causing a computer to execute:
a conference obtainment step of obtaining a video image of a conference and a speech of a participate of the conference as conference information;
a topic extraction step of extracting a topic of the conference from the obtained conference information;
a region identification step of identifying a plurality of image regions included in the video image as attention regions based on the extracted topic;
a relation extraction step of extracting related items related to the attention regions from the speech within a playback time range of the attention regions and contents in the image regions;
a correspondence generation step of generating correspondence entities by associating the attention regions and the related items; and
a group generation step of generating a group by collecting the correspondence entities including the attention regions having a predetermined similarity or more based on contents included in the extracted related items.

2. The non-transitory computer-readable storage medium according to claim 1, wherein the program further causes the computer to execute a representative determination step of determining a representative correspondence entity that is a representative of the correspondence entities included in the group and adding an identifier that identifies the determined representative correspondence entity after the group generation step.

3. The non-transitory computer-readable storage medium according to claim 1, wherein the program further causes the computer to execute a clustering step of dividing the correspondence entities into clusters according to the similarity of the correspondence entity after the correspondence generation step and before the group generation step.

4. The non-transitory computer-readable storage medium according to claim 3, wherein the program further causes the computer to execute a content extraction step of extracting a content common to the correspondence entities for each of the clusters after the clustering step and before the group generation step, and
wherein the correspondence entities included in one cluster are further divided into groups according to the extracted content in the group generation step.

5. The non-transitory computer-readable storage medium according to claim 2, wherein the program further causes the computer to execute, after the group generation step:
a reception step of receiving input of a display instruction to display the group;
a display data generation step of generating display data of the group; and
a display step of displaying the display data,
wherein the display data in which the correspondence entities included in the group are arranged so that the representative correspondence entity is arranged at a top and the other correspondence entities are arranged in chronological order is generated in the display data generation step.

6. The non-transitory computer-readable storage medium according to claim 5, wherein the other correspondence entities in the group are listed in an order of earlier playback start time in the display data generation step.

7. The non-transitory computer-readable storage medium according to claim 3, wherein the program further causes the computer to execute, after the clustering step:
a reception step of receiving input of a display instruction to display the cluster;
a display data generation step of generating display data of the cluster; and
a display step of displaying the display data of the cluster,
wherein the display data of the cluster in which the correspondence entities included in the cluster are arranged in chronological order is generated in the display data generation step.

8. A conference support method comprising:
a conference obtainment step of obtaining a video image of a conference and a speech of a participate of the conference as conference information;
a topic extraction step of extracting a topic of the conference from the obtained conference information;
a region identification step of identifying a plurality of image regions included in the video image as attention regions based on the extracted topic;
a relation extraction step of extracting related items related to the attention regions from the speech within a playback time range of the attention regions and contents in the image regions;
a correspondence generation step of generating correspondence entities by associating the attention regions and the related items; and
a group generation step of generating a group by collecting the correspondence entities including the attention regions having a predetermined similarity or more based on contents included in the extracted related items.

9. A conference support system comprising:
a conference obtainment unit configured to obtain a video image of a conference and a speech of a participate of the conference as conference information;
a topic extraction unit configured to extract a topic of the conference from the obtained conference information;
a region identification unit configured to identify a plurality of image regions included in the video image as attention regions based on the extracted topic;
a relation extraction unit configured to extract related items related to the attention regions from the speech within a playback time range of the attention regions and contents in the image regions;
a correspondence generation unit configured to generate correspondence entities by associating the attention regions and the related items; and
a group generation unit configured to generate a group by collecting the correspondence entities including the attention regions having a predetermined similarity or more based on contents included in the extracted related items.
